(19) United States
(12) Patent Application Publication
(10) Pub. No.: US 2026/0032372 A1
(43) Pub. Date: Jan. 29, 2026

(54) OPEN-EAR EARPHONES

(71) Applicant: Anker Innovations Technology Co. Ltd., Changsha (CN)

(72) Inventors: Xuejun Shan, Shenzhen (CN); Xiaoming Zeng, Shenzhen (CN); Yajun Chen, Shenzhen (CN); Zhiming Huang, Shenzhen (CN); Zhuoyin Hu, Shenzhen (CN); Guoku Zhang, Shenzhen (CN)

(21) Appl. No.: 19/280,307

(22) Filed: Jul. 25, 2025

(30) Foreign Application Priority Data
Jul. 26, 2024 (CN) 202421793962.2

(51) Int. Cl. H04R 1/10

(52) U.S. Cl. CPC H04R 1/1008; H04R 1/105; H04R 1/1058

(57) ABSTRACT

Disclosed are open-ear earphones comprising a first housing, a second housing, a connecting bridge, and an electric connector. The first housing comprises a first electrical device and the second comprises a second electrical device. The connecting bridge is connected to the first housing and the second housing, respectively and comprises a wiring channel. The electric connector is in the wiring channel. A first end of the electric connector extends into the first housing and is electrically connected to the first electrical device, and a second end of the electric connector extends into the second housing and is electrically connected to the second electrical device.

### CROSS-REFERENCE TO RELATED APPLICATION

The present disclosure claims priority of CN Application No. 202421793962.2, filed Jul. 26, 2024, before the China National Intellectual Property Administration, which is incorporated herein by reference in its entirety.

### FIELD

The present disclosure relates to the technical field of earphones, particularly to open-ear earphones.

### BACKGROUND

Open-ear earphones are earphone designed to sit outside the ear canals, allowing users to maintain awareness of their surroundings while enjoying music or taking calls. Among open-ear earphones, an ear-hook design and an ear-clip design (e.g., clip-on) are two common design forms. Ear-hook earphones are fixed above the ear and is supported by a frame around the ear to provide stability and comfort. Ear-clip earphones are attached directly to the auricle (outer ear) by clipping onto it.

Open-ear earphones usually include two chambers and a connecting bridge connecting the two chambers, and a speaker and a battery are disposed in the two chambers, respectively. Therefore, open-ear earphones usually are provided with a wiring connecting the speaker and the battery located in the two chambers.

In the related art, when the wiring passes through the connecting bridge, in-mold injection molding is mainly used and needs to be performed twice to complete full wrapping of the connecting bridge on the wiring. However, since a form of the wiring is difficult to control during the injection molding, breakage is prone to occur, resulting in scrapping of the entire injection molded product and high costs.

### SUMMARY

The disclosure provides earphones (e.g., open-ear phones, earbuds). The disclosure describes structures and methods that can improve production yield of the earphones and reduce production costs thereof.

In a first aspect, disclosed are open-ear earphones comprising a first housing, a second housing, a connecting bridge, and an electric connector. The first housing comprises a first electrical device and the second comprises a second electrical device. The connecting bridge is connected to the first housing and the second housing, respectively and comprises a wiring channel. The electric connector is in the wiring channel. A first end of the electric connector extends into the first housing and is electrically connected to the first electrical device, and a second end of the electric connector extends into the second housing and is electrically connected to the second electrical device.

Based on the open-ear earphones according to the example of the present disclosure, the wiring channel is provided in the connecting bridge, and the electric connector can pass through the wiring channel, thereby achieving the electrical connection between the first electrical device and the second electrical device in the two housings. With the design of the wiring channel, in the assembly process, the electric connector can pass through the wiring channel by threading later so that the electric connector is disposed in a hidden manner, without the need of multiple injection molding production as in a related production method to assemble the electric connector to the connecting bridge. Accordingly, it is possible to effectively avoid a situation where the electric connector is displaced or damaged by high temperatures due to improper fixing in the injection molding production process. Thus, the production yield of the open-ear earphones can be improved and the production costs can be reduced. Further, other advantages of the design are as follows: because the electric connector of the present disclosure can movably pass through the wiring channel, even if the connecting bridge is bent during a wearing process of the open-ear earphones, the electric connector can be adaptively adjusted in the wiring channel, which can effectively reduce the risk of breakage of the electric connector. In the later use process, if the electric connector is damaged, it is convenient to replace the electric connector, thereby extending the service life of the open-ear earphones.

### BRIEF DESCRIPTION OF THE DRAWINGS

In order to more clearly illustrate technical solutions in examples of the disclosure or in the related art, the drawings that need to be used in description of the examples or the related art are briefly introduced below, and it is apparent that the accompanying drawings described below are merely some examples of the present disclosure, and for those of ordinary skill in the art, other drawings can be obtained based on these drawings without inventive work.

FIG. 1 is a schematic diagram of a three-dimensional structure of open-ear earphones according to an example of the present disclosure;

FIG. 2 is a schematic diagram of an exploded structure of the open-ear earphones in FIG. 1 from one perspective;

FIG. 3 is a schematic diagram of an exploded structure of the open-ear earphones in FIG. 1 from another perspective;

FIG. 4 is a schematic cross-sectional view of the open-ear earphones in FIG. 1;

FIG. 5 is a schematic diagram of a structure of the open-ear earphones in FIG. 1 with part of an outer cover of a connecting bridge removed;

FIG. 6 is a schematic diagram of another exploded structure of the open-ear earphones in FIG. 1;

FIG. 7 is a schematic structural diagram of a first housing of the open-ear earphones in FIG. 1; and

FIG. 8 is a schematic structural diagram of a connecting part of the open-ear earphones in FIG. 1.

### DESCRIPTION OF REFERENCE NUMERALS

10: open-ear earphones; 110: sound producing component; 111: first housing; 112: sound output hole; 113: locking through groove; 114: positioning hole; 115: mounting recess; 120: fixing component; 121: second housing; 130: connecting bridge; 131: outer cover; 132: memory metal piece; 134: wiring channel; 135: connecting part; 136: base; 137: lock part; 138: positioning protrusion; 139: wire outlet; 140: electric connector; 141: main body section; 142: first bending section; 143: second bending section; 150: wearing space.

Achievement of the object, functional features and advantages of the disclosure will be further described in combination with examples and with reference to the accompanying drawings.

### DETAILED DESCRIPTION

In order to make the objects, technical solutions, and advantages of the present disclosure more apparent, the present disclosure will be described in detail with reference to the accompanying drawings.

In the following description regarding the drawings, the same numerals in different drawings represent the same or similar elements, unless otherwise indicated. The examples described below are merely examples and do not represent all examples in the present disclosure.

In the description of the present disclosure, it is understood that the terms “first”, “second”, and the like are used for descriptive purposes only and should not be construed as indicating or implying relative importance. For those of ordinary skill in the art, the specific meaning of the above terms in the present disclosure can be understood according to specific circumstances. In the description of the present disclosure, unless otherwise specified, “multiple” means two or more. In addition, “and/or” describes a relationship between associated objects, indicating that there may be three relationships. For example, A and/or B may indicate three cases: A alone, A and B at the same time, and B alone. The symbol “/” generally indicates that the relationship between the associated objects is “or”.

Unless otherwise defined, all technical and scientific terms used herein have the same meanings as generally understood by those skilled in the art of the present disclosure. The terms used in this description are for the purpose of describing specific examples only and are not intended to limit the present disclosure. As used herein, the term “and/or” includes any and all combinations of one or more related listed items.

As a common electronic product, earphones (e.g., earbuds) play an important role in people's lives. Earphones receive electric signals from media players or receivers and convert the electric signals into audible sound waves using speakers close to the ears, allowing users to listen alone without disturbing others. Earphones can also insulate sounds from the surrounding environment, which is very helpful for people using the earphones in noisy environments such as working in a recording studio, working as a DJ, being on a journey, and doing sports. When classified by sound producing mechanisms, earphones include air conduction earphones, bone conduction earphones, etc. When classified by wearing methods, earphones include over-ear earphones, ear-hook earphones, ear-clip earphones, etc.

Open-ear earphones are earphone designed to sit outside the ear canals, allowing users to maintain awareness of their surroundings while enjoying music or taking calls. Among open-ear earphones, an ear-hook design and an ear-clip design (e.g., clip-on) are two common design forms. Ear-hook earphones are fixed above the ear and is supported by a frame around the ear to provide stability and comfort. Ear-clip earphones are attached directly to the auricle (outer ear) by clipping onto it.

Open-ear earphones usually include two chambers and a connecting bridge connecting the two chambers, and a speaker and a battery are disposed in the two chambers, respectively. Therefore, open-ear earphones usually are provided with a wiring connecting the speaker and the battery located in the two chambers.

In the related art, when the wiring passes through the connecting bridge, in-mold injection molding is mainly used and needs to be performed twice to complete full wrapping of the connecting bridge on the wiring. However, since a form of the wiring is difficult to control during the injection molding, breakage is prone to occur, resulting in scrapping of the entire injection molded product and high costs.

In order to solve the above problem, an example of the present disclosure provides open-ear earphones (e.g., earbuds), which can be communicated with devices such as a mobile phone, a computer, an MP3 player, and/or a wearable audio device.

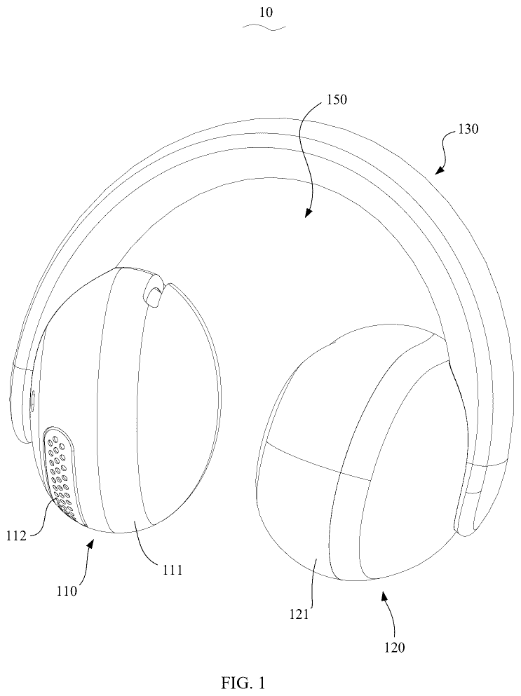

In an example illustrated in FIGS. 1 to 3, open-ear earphones 10 are illustrated using ear-clip earphones as an example. In the example of the present disclosure, the open-ear earphones 10 include a sound producing component 110, a fixing component 120, a connecting bridge 130, and an electric connector 140. Two ends of the connecting bridge 130 may be connected to the sound producing component 110 and the fixing component 120, respectively. The connecting bridge 130 can be configured to be curved. For example, if the open-ear earphones 10 are ear-clip earphones, the connecting bridge 130 can be C-shaped or U-shaped. If the open-ear earphones 10 are ear-hook earphones, the connecting bridge 130 can be an arc-shaped structure that curves along the user's ear. The sound producing component 110, the connecting bridge 130, and the fixing component 120 together may define (e.g., enclose) a wearing space 150. The connecting bridge 130 may provide the earphones an elastic clamping force during wearing. Specifically, the sound producing component 110 may abut against a front side of a user's ear, and the fixing component 120 can be located behind the user's ear. The user's ear can be located in the wearing space 150 and can be clamped by the sound producing component 110 and the fixing component 120.

If the open-ear earphones 10 are ear-hook earphones, the connecting bridge 130 is roughly hook-shaped, which can extend on a back side of the user's ear to hook on the ear. Similarly, the sound producing component 110 is located on a front side of the ear, and the fixing component 120 is located on a back side of the ear. Unlike ear-clip earphones, the connecting bridge 130 in open-ear earphones 10 is not configured to primarily provide a clamping force during wearing.

The sound producing component 110 may include a first housing 111 and a first electrical device. The first electrical device is disposed in the first housing 111. The first housing 111 can be an ellipsoidal and flat three-dimensional structure, or the like. The first housing 111 can be made of plastic, silicone, or the like. For example, the first housing 111 can include an inner housing wall made of hard plastic and a flexible material layer, such as a silicone layer, covering on an outer surface of the inner housing wall, thereby providing better touch. The first housing 111 has sound output holes 112. The first electrical device may be a speaker unit. During use, a sound emitted by the speaker unit enters the user's ear canal through the sound output holes 112 and an opening of the user's ear canal. During wearing of the open-ear earphones 10, the sound producing component 110 may not enter an ear canal (e.g., not inside the ear canal), and the sound output holes 112 may face the opening of the ear canal.

The fixing component 120 may include a second housing 121 and a second electrical device. The second electrical device is disposed in the second housing 121. The open-ear earphones 10 may further include a control circuit board and a battery. The control circuit board can be disposed in the first housing 111 together with the speaker unit, or can be disposed in the second housing 121 together with the battery.

The electric connector 140 of the present disclosure can electrically connect the battery and the control circuit board, and/or electrically connect the speaker unit and the control circuit board. For example, the first electrical device can be the control circuit board or the speaker unit, and the second electrical device can be the battery or the control circuit board. The battery can be a rechargeable lithium battery, and during operation, the battery supplies power to the control circuit board and the speaker unit.

Regardless of whether the control circuit board is disposed in the first housing 111 or the second housing 121, it may be necessary to achieve the electrical connection between electronic components in the first housing 111 and the second housing 121 in the open-ear earphones 10. Therefore, the electric connector 140 needs to pass through the connecting bridge 130 to achieve electrical conduction between the first electrical device and the second electrical device. It can be understood that during actual operation, the speaker unit and the battery are both connected to the control circuit board, and the control circuit board provides power and control signals for the speaker unit. Therefore, in an arrangement form, when the first electrical device is the speaker unit and the second electrical device is the control circuit board, that is, in a case where the control circuit board and the battery are disposed together in the second housing 121, the electric connector 140 physically connects the speaker unit and the control circuit board, and can transmit the power and control signals of the control circuit board to the speaker unit to implement a normal sound output function of the speaker unit.

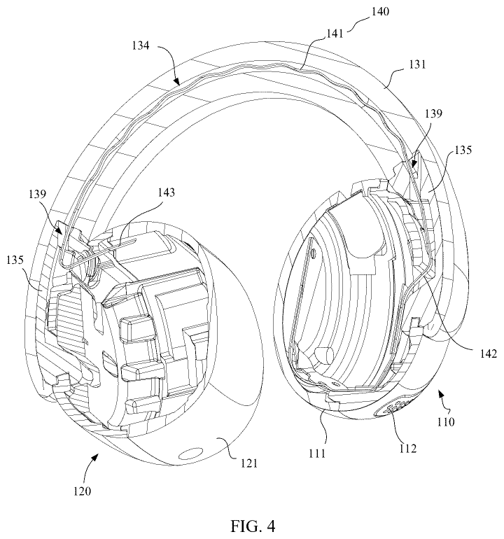

Referring to FIG. 4, in order to implement arrangement of the electric connector 140, the present disclosure further provides a wiring channel 134 in the connecting bridge 130. The electric connector 140 may movably pass through the wiring channel 134. One end of the electric connector 140 extends into the first housing 111 and is electrically connected to the first electrical device, and the other end thereof extends into the second housing 121 and is electrically connected to the second electrical device. Further, the electric connector 140 may be movable along a length direction of the wiring channel 134 so as to facilitate a threading operation. Specifically, the electric connector 140 can be pulled relative to an inner wall of the wiring channel 134.

Based on the open-ear earphones 10 according to the example of the present disclosure, the wiring channel 134 is provided in the connecting bridge 130 and the electric connector 140 can pass through the wiring channel 134, thereby achieving the electrical connection between the first electrical device and the second electrical device in the two housings. With the design of the wiring channel 134, in the assembly process, the electric connector 140 can pass through the wiring channel 134 by threading later so that the electric connector 140 is disposed in a hidden manner, without the need of multiple injection molding production as in a related production method to assemble the electric connector 140 to the connecting bridge 130. Accordingly, it is possible to effectively avoid a situation where the electric connector 140 is displaced or damaged by high temperatures due to improper fixing in the injection molding production process. Thus, the production yield of the open-ear earphones 10 can be improved and the production costs can be reduced. Further, other advantages of the design are as follows: since the electric connector 140 of the present disclosure can movably pass through the wiring channel 134, even if the connecting bridge 130 is bent during a wearing process of the open-ear earphones, the electric connector 140 can be adaptively adjusted in the wiring channel 134, which can effectively reduce the risk of breakage of the electric connector 140. In the later use process, if the electric connector 140 is damaged, it is convenient to replace the electric connector 140, thereby extending the service life of the open-ear earphones 10.

In an example, the connecting bridge 130 includes an outer cover 131 and a memory metal piece 132. The memory metal piece 132 is accommodated in the outer cover 131, two ends of which are respectively connected to the first housing 111 and the second housing 121. The wiring channel 134 is provided in the outer cover 131.

The outer cover 131 may be made of a material with certain elasticity, such as plastic or silicone. The memory metal piece 132 may be a titanium wire. The memory metal piece 132 may be in a long strip shape and may extend along a length direction of the outer cover 131. The memory metal piece 132 is wrapped by the outer cover 131 so that the connecting bridge 130 has better deformation resilience. During the production process, the memory metal piece 132 can be fixed together with the outer cover 131 by pre-embedding. The wiring channel 134 can be molded together with the outer cover 131 during the molding process. In an implementation, a dummy wire can be pre-embedded and then injection-molded together with the outer cover 131 After the injection molding, the dummy wire is separated from the material of the outer cover 131, and the wiring channel 134 is formed at the position of the dummy wire.

The memory metal piece 132 and the wiring channel 134 of the present disclosure may extend in parallel along the length direction of the outer cover 131. The wiring channel 134 and the memory metal piece 132 are separated from each other, and a curvature of extension of the wiring channel 134 is equivalent to a curvature of the memory metal piece 132. In this way, during bending deformation of the entire connecting bridge 130, the electric connector 140 can move freely in the wiring channel 134, thereby preventing the electric connector 140 from being broken.

It is understandable that in some examples, the connecting bridge 130 of the present disclosure may not be provided with the memory metal piece 132 but only the outer cover 131. The outer cover 131 may be made of a material with a certain degree of elastic recovery, such as plastic, silicone, or metal, which is not limited in the present disclosure.

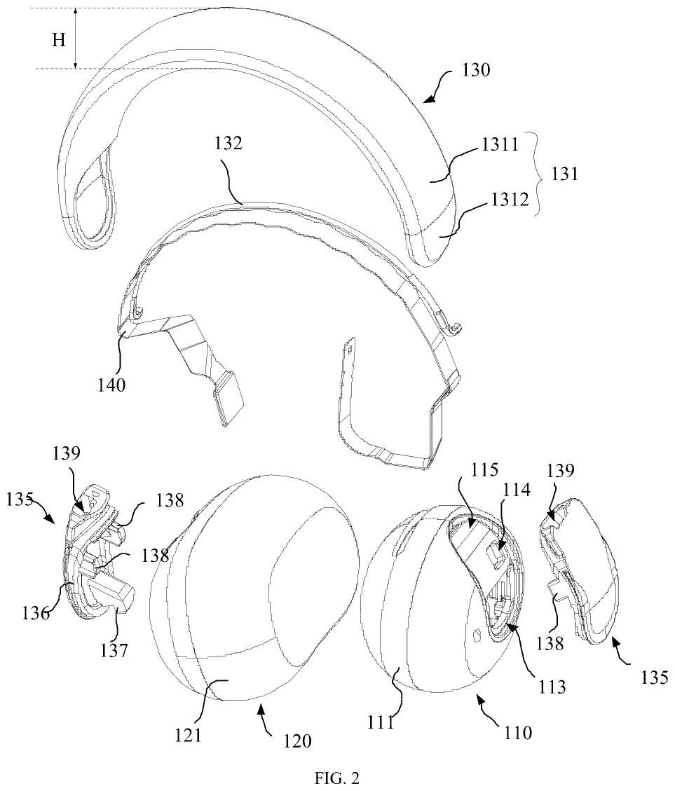

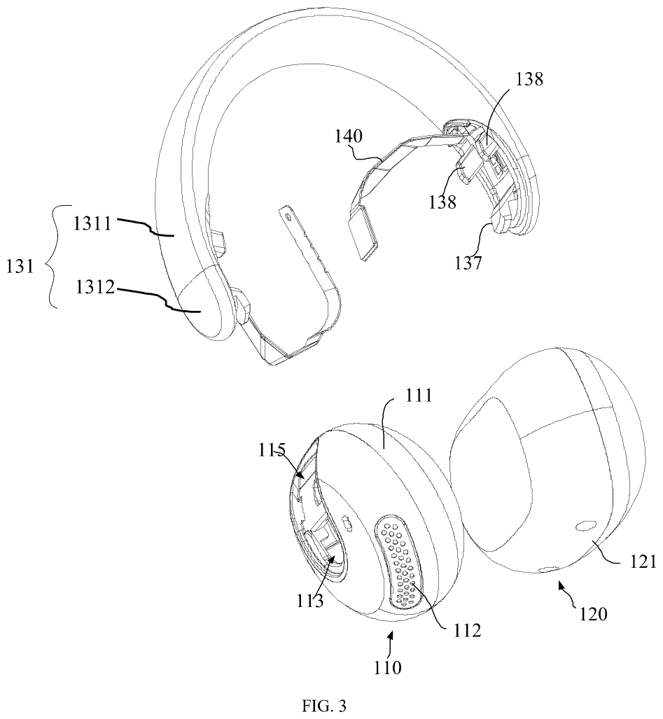

As illustrated in FIGS. 2 and 3, the outer cover 131 includes an outer cover body 1311 and an outer cover cap 1312. The outer cover cap 1312 is capped onto the outer cover body 1311, and the wiring channel 134 is formed between the outer cover body 1311 and the outer cover cap 1312.

The electric connector 140 may have a sheet-like structure or a wavy structure in the wiring channel 134. The shape of the wiring channel 134 may match the shape of the electric connector 140, which facilitates the electric connector 140 to maintain its posture stability without twisting during the threading process, so that the threading process is smoother.

In an example, the electric connector 140 may include a first bending section 142, a main body section 141 and a second bending section 143 connected in sequence. The main body section 141 extends in the wiring channel 134. The first bending section 142 may extend in a zigzag manner in the first housing 111 and is electrically connected to the first electrical device. The second bending section 143 may extend in a zigzag manner in the second housing 121 and is electrically connected to the second electrical device.

During actual use of the open-ear earphones 10 of the present example, when the connecting bridge 130 is bending-deformed, the electric connector 140 is further pulled. Since the electric connector 140 is provided with the first bending section 142 and the second bending section 143, a larger allowance for stretching of the entire electric connector 140 is provided by the first bending section 142 and the second bending section 143. In this way, during the bending deformation of the connecting bridge 130, a connecting portion of the electric connector 140 and the first electrical device may not be pulled, and a connecting portion of the electric connector 140 and the second electrical device may not be pulled, thereby effectively ensuring conductive contact and improving the operating stability of the entire open-ear earphones 10.

Further, the first bending section 142 may bend around the first electrical device along a first bending direction, and the second bending section 143 may bend around the second electrical device along a second bending direction, the first bending direction being different from the second bending direction.

In a form exemplarily illustrated in FIGS. 2 to 4, the first bending section 142 bends and extends around a side of the first electrical device away from the connecting bridge 130; while the second bending section 142 bends and extends around a side of the second electrical device facing the connecting bridge 130. By such arrangement, while achieving reasonable layout of the wires, relatively short wiring is adopted, so that the electric connector 140 has the allowance for stretching as large as possible during the bending deformation of the connecting bridge 130, thereby effectively reducing the phenomenon of pulling on a welded portion for electrical connection of the electric connector 140 and improving stability of the electrical connection.

In addition, the main body section 141 can be a sheet-like structure or a wavy structure. When the main body section 141 is a sheet-like structure, a thickness direction of the main body section 141 can be set same as a thickness direction of the connecting bridge 130. As illustrated in FIG. 2, H in the figure is the thickness direction of the connecting bridge 130. With such arrangement, during the bending deformation of the connecting bridge 130, a deformation direction of the main body section 141 is the same, which can effectively reduce the risk of damage to the main body section 141 due to stress concentration. When the main body section 141 is a wavy structure, a larger allowance for deformation of the entire electric connector 140 during the pulling process is provided, and a risk of the electric connector 140 being damaged during the bending deformation of the connecting bridge 130 and a risk of the electrically welded portion being loosened due to pulling can be reduced.

In an example, the electric connector 140 may be a flexible printed circuit (FPC), so that power and signal transmission to the first electrical device can be implemented with a smaller number of wires. In this way, when the flexible circuit board has a portion with a wavy structure, the electric connector 140 has a greater deformation capability during the bending deformation of the connecting bridge 130, and is not prone to be damaged or broken, thus extending the service life. It is understandable that the electric connector 140 of the present disclosure may use other wire forms, such as multiple single-core cables, multi-core cables, or the like, which is not limited in the present disclosure.

In the present disclosure, one end of the outer cover 131 may be detachably connected to the first housing 111 and the other end thereof may be fixedly connected to the second housing 121. In this case, in order to achieve higher threading efficiency during the production process, the second housing 121 may be formed by joining multiple separate sub-housings, and the outer housing 131 may be fixedly connected to one of the sub-housings, so that threading can be performed when the second housing 121 is open. One end of the outer cover 131 may be fixedly connected to the first housing 111 and the other end thereof may be detachably connected to the second housing 121. The threading process in this form is similar to that in the above content and will not be repeated here.

In addition, in the present disclosure, the two ends of the outer cover 131 may be detachably connected to the first housing 111 and the second housing 121, respectively. With such arrangement, the electric connector 140 can pass through the connecting bridge 130 in advance and then assembled with the first housing 111 and the second housing 121, so that modular assembly can be achieved, which can greatly improve production efficiency. Further, it is convenient to connect wires after detaching the connecting bridge 130 during a later maintenance process.

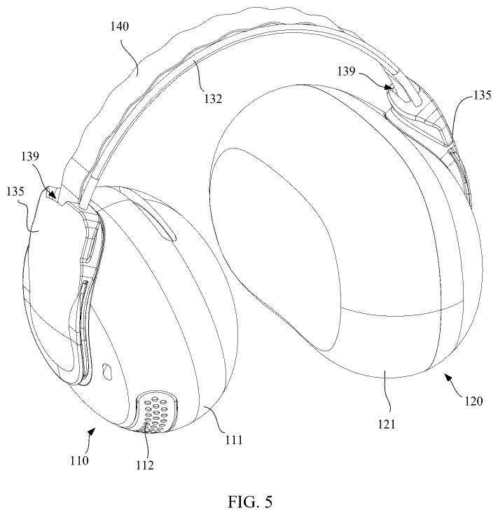

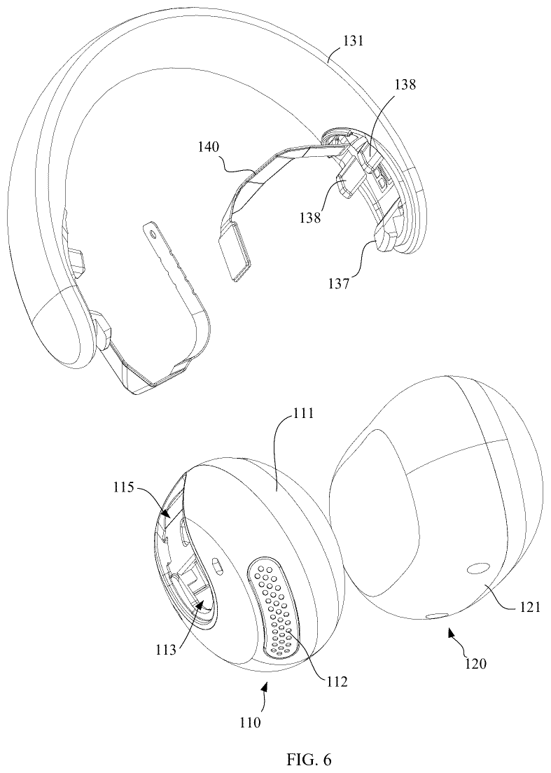

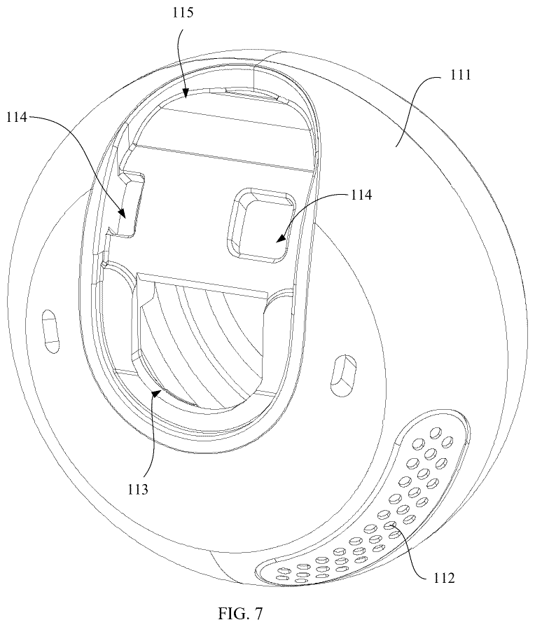

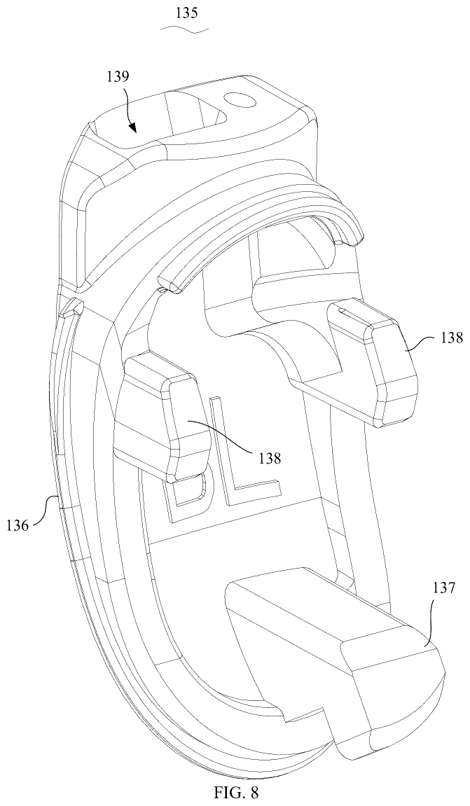

Referring to FIGS. 5 to 8, in a specific detachable connection form, the two ends of the outer cover 131 are respectively locked with the first housing 111 and the second housing 121.

Specifically, in an arrangement form, the open-ear earphones 10 according to the present disclosure can also be provided with connecting parts 135 at both ends of the outer cover 131. The outer cover 131 is provided in an arc shape, and the two connecting parts 135 are respectively connected to the two ends of the outer cover 131. The memory metal piece 132 extends in the outer cover 131, and two ends of the memory metal piece 132 extend into the connecting parts 135, respectively. Each of the connecting parts 135 may be provided with a lock part 137, and both the first housing 111 and the second housing 121 may be provided with a locking through groove 113, into which the lock part 137 is locked.

In this example, the connecting parts 135 are provided at both ends of the outer cover 131. Hardness of the connecting part 135 is greater than hardness of the outer cover 131. The connecting part 135 and the outer cover 131 can be molded into an integral structure by secondary injection molding, or fixed as one by bonding, hot melting, or the like, so that the outer cover 131 mainly fulfills a function of deformation to generate resilience, while the connecting parts 135 fulfill a connecting function. In this way, connection is made using the connecting parts 135 with larger hardness, and the connection is firmer. The connecting parts 135 are connected to the first housing 111 and the second housing 121 in a locking manner, so that during the assembly process, other tools may be less needed, and assembly and disassembly are more convenient.

Specifically, the connecting part 135 may include a base 136, and the lock part 137 is connected to the base 136. A cross-section of the lock part 137 roughly presents a shape of the numeral “7” (e.g., a horizontal segment connected to a downward slanting segment), and the lock part 137 protrudes from a side of the base 136, so that the lock part 137 and the base 136 fit to form a limiting groove. During the assembly process, the lock part 137 may pass through the locking through groove 113, and a wall of the first housing 111 may be embedded in the limiting groove, and a hook portion of the lock part 137 may abut against an inner wall of the first housing 111, thereby achieving relative fixation of the connecting part 135 and the first housing 111.

Further, in order to improve the convenience and stability of assembly, a positioning protrusion 138 may be provided on the connecting part 135, positioning holes 114 are provided on both the first housing 111 and the second housing 121, and the positioning protrusion 138 is inserted into the positioning hole 114. Specifically, the positioning protrusions 138 may be fixed on the base 136 and are located on the same side of the base 136 as the lock part 137. The positioning protrusions 138 may be spaced apart from the lock part 137, and the lock part 137 is located on a side of the connecting part 135 away from the outer cover 131. Through spaced arrangement of the positioning protrusions 138 and the lock part 137, in one hand, the alignment of the connecting bridge 130 with the first housing 111 and the second housing 121 is more convenient; in the other hand, after the connection is made, the connection is firmer and is unlikely to get loose by limitation at the two portions.

In an example, outer surfaces of the first housing 111 and the second housing 121 may be both provided with a mounting recess 115. One connecting part 135 may be correspondingly provided in one mounting recess 115, and the locking through groove 113 may be provided in a wall of the mounting recess 115. The mounting recess 115 enables at least part of the structure of the connecting part 135 to be accommodated therein, so as to facilitate realizing close contact between the outer cover 131 of the connecting bridge 130 and the first housing 111 and the second housing 121, thereby reducing a size of a gap between the outer cover 131 and the first housing 111 and a size of a gap between the outer cover 131 and the second housing 121 and improving the sealing performance.

The two connecting parts 135 of the present disclosure are provided with wire outlets 139 respectively, and the wire outlets 139 are in communication with the wiring channel 134. The first housing 111 is provided with a first wire passing opening, and the second housing 121 is provided with a second wire passing opening. One end of the electric connector 140 passes through the wire outlet 139, then enters the first housing 111 through the first wire passing opening and is connected to the first electrical device; the other end of the electric connector 140 passes through the wire outlet 139, then passes through the second wire passing opening and is electrically connected to the second electrical device. Further, the first wire passing opening and the second wire passing opening may be common to the locking through grooves 113 or may be separately provided. Two positioning protrusions 138 provided on the connecting part 135 may be spaced apart, and the wire outlet 139 in each of the connecting parts 135 may be provided between the two positioning protrusions 138. In this way, when the electric connector 140 passes, the positioning protrusions 138 can also limit and guide the electric connector 140.

Because the connecting part 135 of the present disclosure is disposed on a side of the outer cover 131 facing the wearing space 150, after assembly, the connecting part 135 is basically hidden in the mounting recess 115. At this time, the wire outlet 139 is covered by the first housing 111 and is not exposed, and the wire outlet 139 is covered by the second housing 121 and is not exposed. With such arrangement, the entire electric connector 140 is of a hidden design, and the sealing performance is better.

It should be noted that, for the detachable connection between the two ends of the connecting bridge 130 or the outer cover 131 and the first housing 111 and the second housing 121, in addition to the above examples, the connecting part 135 may not be provided, that is, the outer cover 131 is directly connected to the first housing 111 and the second housing 121. In this case, the specific connection form, in addition to locking connection, may also be threaded connection, plug-in connection, magnetic connection, or the like, which is not limited in the present disclosure.

During the production and assembly process of the open-ear earphones according to the present disclosure, the connecting bridge 130 alone can be threaded. For example, a traction band can adhere to one end of the electric connector 140. The traction band can be a soft PET (polyethylene terephthalate) sheet. By utilizing the deformation ability and toughness of the traction band, the electric connector 140 further passes through the wiring channel 134 after passing through the two wire outlets 139. In this way, while achieving quick threading operation, the structural integrity of the electric connector 140 can be guaranteed as much as possible, thereby improving product yield.

The same or similar reference numerals in the drawings of the example correspond to the same or similar components. In the description of the present disclosure, it should be understood that if the terms “up”, “down”, “left”, “right”, and the like indicate directions or positional relationships based on the directions or positional relationships shown in the drawings, it is only for the convenience of describing the disclosure and simplifying the description, and does not indicate or imply that the device or element referred to must have a specific direction, be constructed and operated in a specific direction. Therefore, the terms describing the positional relationship in the drawings are only used for illustrative purposes and cannot be understood as limitations on the present disclosure. For those of ordinary skill in the art, the specific meanings of the above terms can be understood according to specific circumstances.

The above are only preferred examples of the present disclosure and are not intended to limit the present disclosure. Any modifications, equivalent substitutions and improvements made within the spirit and principles of the present disclosure should be included in the protection scope of the present disclosure.

What is claimed is:

1. Open-ear earphones comprising:
a first housing comprising a first electrical device;
a second housing comprising a second electrical device;
a connecting bridge connected to the first housing and the second housing, respectively, wherein the connecting bridge comprises a wiring channel; and
an electric connector in the wiring channel, wherein a first end of the electric connector extends into the first housing and is electrically connected to the first electrical device, and a second end of the electric connector extends into the second housing and is electrically connected to the second electrical device.

2. The open-ear earphones of claim 1, wherein the electric connector comprises a flexible printed circuit.

3. The open-ear earphones of claim 1, wherein the electric connector comprises a wire with a deformation capability.

4. The open-ear earphones of claim 1, wherein a shape of the wiring channel matches a shape of the electric connector, and the electric connector is movable along a length direction of the wiring channel.

5. The open-ear earphones of claim 1, wherein:
the connecting bridge comprises an outer cover,
two ends of outer cover are connected to the first housing and the second housing, respectively, and
the wiring channel is inside the outer cover.

6. The open-ear earphones of claim 5, wherein the outer cover is made of a material with elastic recovery capability.

7. The open-ear earphones of claim 1, wherein the connecting bridge comprises an outer cover and a memory metal piece in the outer cover; and
two ends of the outer cover are connected to the first housing and the second housing, respectively.

8. The open-ear earphones of claim 7, wherein the memory metal piece and the wiring channel extend in parallel along a length direction of the outer cover.

9. The open-ear earphones of claim 5, wherein the outer cover comprises an outer cover body and an outer cover cap, and
the outer cover cap is capped onto the outer cover body, and the wiring channel is formed between the outer cover body and the outer cover cap.

10. The open-ear earphones of claim 1, wherein:
the electric connector comprises a first bending section, a main body section, and a second bending section connected in sequence,
the main body section extends in the wiring channel,
the first bending section extends in a zigzag shape in the first housing and is electrically connected to the first electrical device, and
the second bending section extends in a zigzag shape in the second housing and is electrically connected to the second electrical device.

11. The open-ear earphones of claim 10, wherein the main body section is a wavy structure or a sheet-like structure.

12. The open-ear earphones of claim 10, wherein the main body section is a sheet-like structure, and a thickness direction of the main body section is the same as a thickness direction of the connecting bridge.

13. The open-ear earphones of claim 10, wherein the main body section comprises a flexible printed circuit, and the flexible printed circuit has a deformation capability during bending deformation of the connecting bridge.

14. The open-ear earphones of claim 10, wherein the first bending section bends around the first electrical device along a first bending direction, and the second bending section bends around the second electrical device along a second bending direction, the first bending direction being different from the second bending direction.

15. The open-ear earphones of claim 5, wherein the outer cover is detachably connected to at least one of the first housing or the second housing.

16. The open-ear earphones of claim 15, further comprising connecting parts at respective ends of the outer cover, wherein:
each of the connecting parts comprises a respective lock, and
each of the first housing and the second housing is provided with a respective locking through groove, into which the respective lock is locked.

17. The open-ear earphones of claim 16, wherein a respective positioning protrusion is provided on each of the connecting parts, a respective positioning hole is provided on each of the first housing and the second housing, and the respective positioning protrusion is inserted into the respective positioning hole, or
each of outer surfaces of the first housing and the second housing comprises a respective mounting recess, one of the connecting parts is correspondingly provided in the respective mounting recess, and the respective locking through groove is provided in a wall of the mounting recess.

18. The open-ear earphones of claim 16, wherein the connecting bridge comprises an outer cover and a memory metal piece, and wherein the memory metal piece extends in the outer cover, and two ends of the memory metal piece extend into the connecting parts, respectively.

19. The open-ear earphones of claim 16, wherein each of the two connecting parts comprises a respective wire outlet, the two wire outlets are in communication with the wiring channel, and two ends of the electric connector pass through the two wire outlets respectively; and
the wire outlet on one of the connecting parts is covered by the first housing and is not exposed, and the wire outlet on the other of the connecting parts is covered by the second housing and is not exposed.

20. Earphones comprising:
a first housing comprising a first electrical device;
a second housing comprising a second electrical device;
a wiring channel between the first housing and the second housing; and
an electric connector in the wiring channel, wherein a first end of the electric connector extends into the first housing and is electrically connected to the first electrical device, and a second end of the electric connector extends into the second housing and is electrically connected to the second electrical device.
